(19) United States
(12) Patent Application Publication
(10) Pub. No.: US 2025/0303336 A1
(43) Pub. Date: Oct. 2, 2025

(54) HONEYCOMB STRUCTURE

(71) Applicant: NGK INSULATORS, LTD., Nagoya-City (JP)

(72) Inventors: Yudai KURIMOTO, Shanghai (CN); Katsunori TANAKA, Nagoya-Shi (JP)

(73) Assignee: NGK INSULATORS, LTD., Nagoya-City (JP)

(21) Appl. No.: 19/070,797

(22) Filed: Mar. 5, 2025

(30) Foreign Application Priority Data
Mar. 29, 2024 (JP) 2024-058032

(51) Int. Cl. B01D 46/24; B01D 39/20

(52) U.S. Cl. CPC B01D 46/2484; B01D 39/2075; B01D 46/24491; B01D 46/24492; B01D 46/247; B01D 46/2474; B01D 46/2482; B01D 2239/1208; B01D 2239/1216; B01D 2239/1291; B01D 2279/30

(57) ABSTRACT

A pillar-shaped honeycomb structure,
wherein a cell density based on a total number of a plurality of inlet cells and a plurality of outlet cells is 29 to 43 cells/cm²,
wherein an average thickness of partition walls is 0.173 mm or more and 0.236 mm or less, and
wherein assuming an average value of opening diameters of the plurality of outlet cells except for those adjacent to an outer peripheral side wall is Dₒᵤₜ, and an average value of opening diameters of the plurality of inlet cells except for those adjacent to the outer peripheral side wall is Dᵢₙ, 1.20≤Dᵢₙ/Dₒᵤₜ≤1.38 is satisfied.

### CROSS REFERENCE TO RELATED APPLICATIONS

The present invention claims the benefit of priority to Japanese Patent Application No. 2024-58032 filed on Mar. 29, 2024 with the Japanese Patent Office, the entire contents of which are incorporated herein by reference in its entirety.

### FIELD OF THE INVENTION

The present invention relates to a honeycomb structure.

### BACKGROUND OF THE INVENTION

Diesel engines have better thermal efficiency than gasoline engines, but they generate particulate matter (PM) such as soot and ash due to diffusive combustion. This particulate matter is known to be carcinogenic, so it is essential to prevent its release into the atmosphere. For this reason, in addition to the conventional weight-based quantity restrictions, strict PM count restrictions are now being imposed, mainly in Europe.

However, there are limits to how much PM emissions can be reduced by improving combustion, and the only effective measure currently available is to install a filter called a DPF (Diesel Particulate Filter) in the exhaust. As this filter, a wall-flow type filter designed such that exhaust gas passes through porous partition walls is effective. Specifically, the wall-flow type filter has a large number of inlet cells and a large number of outlet cells adjacent to each other via porous partition walls, and can be configured with a honeycomb structure that captures PM while the exhaust gas passes through the partition walls.

Wall-flow type filters comprised of honeycomb structures have a problem in that PM accumulates in the filter as the operating time increases, resulting in increased pressure loss. For this reason, extra fuel is injected every time a certain amount of PM accumulates in the filter, thereby increasing the exhaust gas temperature and burning the soot (filter regeneration), and thereby reducing the pressure loss. In addition, since ash does not burn even at high temperatures, trucks and off-road vehicles, which travel longer distances (that is, the filter operating time is longer) than passenger cars, require regular cleaning of the honeycomb structure to remove the ash that accumulates in the filter and to reduce the pressure loss. If the pressure loss due to PM accumulation increases quickly, filter regeneration and cleaning treatment will need to be performed more frequently, resulting in increased fuel consumption and maintenance costs. Accordingly,, efforts have been made to reduce the pressure loss due to PM accumulation by modifying the arrangement and size of the inlet cells and the outlet cells (Patent Literature 1 and Patent Literature 2).

### PRIOR ART

### Patent Literature

[Patent Literature 1] WO 2019/104057 A1
[Patent Literature 2] WO 2013/187444 A1

### SUMMARY OF THE INVENTION

Conventionally, the timing of filter regeneration or cleaning treatment has been determined by measuring the pressure loss between the inlet and outlet of the filter using a pressure sensor. However, if the pressure loss remains low after a large amount of PM has accumulated in the filter, when filter regeneration control is performed using a pressure sensor, it becomes increasingly difficult to predict the amount of PM accumulation due to the pressure loss, resulting in excessive PM accumulation and possible damage to the filter. Therefore, it is desirable to reduce the frequency of filter regeneration and cleaning treatment and thereby reduce maintenance costs by preventing excessive pressure loss after PM accumulation, while at the same time making it easier for the pressure sensor to detect the amount of PM accumulation suitable for filter regeneration and cleaning treatment by increasing the amount of change in pressure loss (pressure loss gradient) corresponding to the amount of PM accumulated. On the other hand, the honeycomb structure is also required to have a heat capacity that prevents damage due to an excessive increase in temperature during filter regeneration.

The present invention has been made in consideration of the above-mentioned circumstances, and in one embodiment, an object is to provide a honeycomb structure that can satisfy all of the required characteristics, namely, having a practical heat capacity, being able to keep maintenance costs low, and being able to easily detect the time when maintenance is necessary using a pressure sensor based on the amount of PM accumulation.

As a result of intensive research by the present inventors to solve the above-mentioned problems, it has been found that an appropriate combination of parameters related to the honeycomb structure, such as the cell density, the average thickness of the partition walls, the opening diameter ratio, and the average porosity of the partition walls, is effective to solve the problems, and the present invention has been completed as exemplified below.

### Aspect 1

A pillar-shaped honeycomb structure, comprising:
an outer peripheral side wall;
a plurality of inlet cells arranged on an inner peripheral side of the outer peripheral side wall, extending from an inlet end surface to an outlet end surface, having an opening at the inlet end surface, and having a sealing portion at the outlet end surface; and
a plurality of outlet cells arranged on the inner peripheral side of the outer peripheral side wall, extending from the inlet end surface to the outlet end surface, having a sealing portion at the inlet end surface, and having an opening at the outlet end surface;
wherein at least a part of the plurality of inlet cells are adjacent to at least a part of the plurality of outlet cells with each of partition walls interposed therebetween,
wherein a cell density based on a total number of the plurality of inlet cells and the plurality of outlet cells is 29 to 43 cells/cm²,
wherein an average thickness of the partition walls is 0.173 mm or more and 0.236 mm or less, and
wherein assuming an average value of opening diameters of the plurality of outlet cells except for those adjacent to the outer peripheral side wall is Dₒᵤₜ, and an average value of opening diameters of the plurality of inlet cells except for those adjacent to the outer peripheral side wall is Dᵢₙ, 1.20≤Dᵢₙ/Dₒᵤₜ≤1.38 is satisfied.

### Aspect 2

The honeycomb structure according to aspect 1, wherein the average value Dᵢₙ of the opening diameters of the plurality of inlet cells except for those adjacent to the outer peripheral side wall is 1.48 mm or more and 1.80 mm or less, and
the average value Dₒᵤₜ of the opening diameters of the plurality of outlet cells except for those adjacent to the outer peripheral side wall is 1.16 mm or more and 1.48 mm or less.

### Aspect 3

The honeycomb structure according to aspect 1 or 2, wherein the partition walls have an average porosity of 52 to 60%.

### Aspect 4

The honeycomb structure according to any one of aspects 1 to 3, wherein a density measured based on outer dimensions is 0.288 to 0.410 g/cm³.

### Aspect 5

The honeycomb structure according to any one of aspects 1 to 4, wherein a ratio of a number of the plurality of inlet cells except for those adjacent to the outer peripheral side wall to a number of the plurality of outlet cells except for those adjacent to the outer peripheral side wall is 0.9 to 1.1.

### Aspect 6

The honeycomb structure according to one of aspects 1 to 5, wherein when a deposition mass of particulate matter comprising soot per unit volume of the honeycomb structure is 1 g/L, assuming a pressure loss when exhaust gas having a temperature of 250° C. and a flow rate of 480 kg/hr passes from the inlet end surface to the outlet end surface is defined as P₁, and
when a deposition mass of particulate matter comprising soot per unit volume of the honeycomb structure is 3 g/L, assuming a pressure loss when exhaust gas having a temperature of 250° C. and a flow rate of 480 kg/hr passes from the inlet end surface to the outlet end surface is defined as P₂,

$$45 \% \leq ( {P}_{2} - {P}_{1} ) / {P}_{1} is satisfied .$$

### Aspect 7

The honeycomb structure according to any one of aspects 1 to 6, wherein the partition walls comprise cordierite.

### Aspect 8

A pillar-shaped honeycomb structure, comprising:
an outer peripheral side wall;
a plurality of inlet cells arranged on an inner peripheral side of the outer peripheral side wall, extending from an inlet end surface to an outlet end surface, having an opening at the inlet end surface, and having a sealing portion at the outlet end surface; and
a plurality of outlet cells arranged on the inner peripheral side of the outer peripheral side wall, extending from the inlet end surface to the outlet end surface, having a sealing portion at the inlet end surface, and having an opening at the outlet end surface;
wherein at least a part of the plurality of inlet cells are adjacent to at least a part of the plurality of outlet cells with each of partition walls interposed therebetween,
wherein a cell density based on a total number of the plurality of inlet cells and the plurality of outlet cells is 29 to 36 cells/cm²,
wherein an average thickness of the partition walls is 0.231 mm or more and 0.312 mm or less,
wherein assuming an average value of opening diameters of the plurality of outlet cells outlet cells except for those adjacent to the outer peripheral side wall is Dₒᵤₜ, and an average value of opening diameters of the plurality of inlet cells except for those adjacent to the outer peripheral side wall is Dᵢₙ, 1.14≤Dᵢₙ/Dₒᵤₜ≤1.37 is satisfied, and
wherein the partition walls have an average porosity of 57 to 63%.

### Aspect 9

The honeycomb structure according to aspect 8, wherein the average value Dᵢₙ of the opening diameters of the plurality of inlet cells except for those adjacent to the outer peripheral side wall is 1.52 mm or more and 1.76 mm or less, and
the average value Dₒᵤₜ of the opening diameters of the plurality of outlet cells except for those adjacent to the outer peripheral side wall is 1.20 mm or more and 1.44 mm or less.

### Aspect 10

The honeycomb structure according to aspect 8 or 9, wherein an average pore diameter of the partition walls is 7 to 13 μm.

### Aspect 11

The honeycomb structure according to any one of aspects 8 to 10, wherein a density measured from outer dimensions is 0.288 to 0.410 g/cm³.

### Aspect 12

The honeycomb structure according to any one of aspects 8 to 11, wherein a ratio of a number of the plurality of inlet cells except for those adjacent to the outer peripheral side wall to a number of the plurality of outlet cells except for those adjacent to the outer peripheral side wall is 0.9 to 1.1.

### Aspect 13

The honeycomb structure according to any one of aspects 8 to 12, wherein when a deposition mass of particulate matter comprising soot per unit volume of the honeycomb structure is 1 g/L, assuming a pressure loss when exhaust gas having a temperature of 250° C. and a flow rate of 480 kg/hr passes from the inlet end surface to the outlet end surface is defined as P₁, and
when a deposition mass of particulate matter comprising soot per unit volume of the honeycomb structure is 3 g/L, assuming a pressure loss when exhaust gas having a temperature of 250° C. and a flow rate of 480 kg/hr passes from the inlet end surface to the outlet end surface is defined as P₂,

$$45 \% \leq ( {P}_{2} - {P}_{1} ) / {P}_{1} is satisfied .$$

### Aspect 14

The honeycomb structure according to any one of aspects 8 to 13, wherein the partition walls comprise cordierite.

By using the honeycomb structure according to one embodiment of the present invention as an exhaust gas filter, it is possible to reduce the frequency of filter regeneration and cleaning treatment by preventing excessively large pressure loss after PM accumulation, and at the same time, by increasing the amount of change in pressure loss (pressure loss gradient) corresponding to the amount of accumulated PM, it is possible to make it easier for a pressure sensor to detect the amount of PM accumulation suitable for filter regeneration and cleaning treatment. This makes it possible to obtain a filter that can keep maintenance costs low and easily detect when maintenance is required using a pressure sensor based on the amount of accumulated PM. Therefore, it is possible to reduce the risk of the filter being damaged due to excessive accumulation of PM. Furthermore, the honeycomb structure according to one embodiment of the present invention has a practical heat capacity, so there is a low risk of damage due to an excessive increase in temperature during filter regeneration. As described above, according to one embodiment of the present invention, it can be said that a honeycomb structure which is extremely excellent in practical use can be provided.

### BRIEF DESCRIPTION OF THE DRAWINGS

FIG. 1 is a perspective view showing a wall-flow type honeycomb structure.

FIG. 2 is a schematic cross-sectional view of a wall-flow type honeycomb structure observed from a cross section parallel to the direction in which the cells extend.

FIG. 3 is a schematic partial enlarged view of a partition wall of a honeycomb structure observed from a cross section orthogonal to the direction in which the cells extend.

FIG. 4 is an explanatory diagram showing a schematic example of a method for forming sealing portions using a squeegee method.

### DETAILED DESCRIPTION OF THE INVENTION

Hereinafter, embodiments of the present invention will now be described in detail with reference to the drawings. It should be understood that the present invention is not intended to be limited to the following embodiments, and any change, improvement or the like of the design may be appropriately added based on ordinary knowledge of those skilled in the art without departing from the spirit of the present invention.

### 1. HONEYCOMB STRUCTURE

### (1-1) Basic Structure

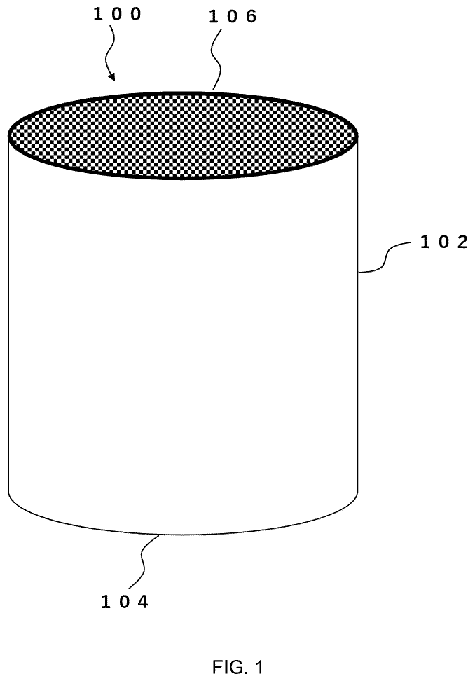

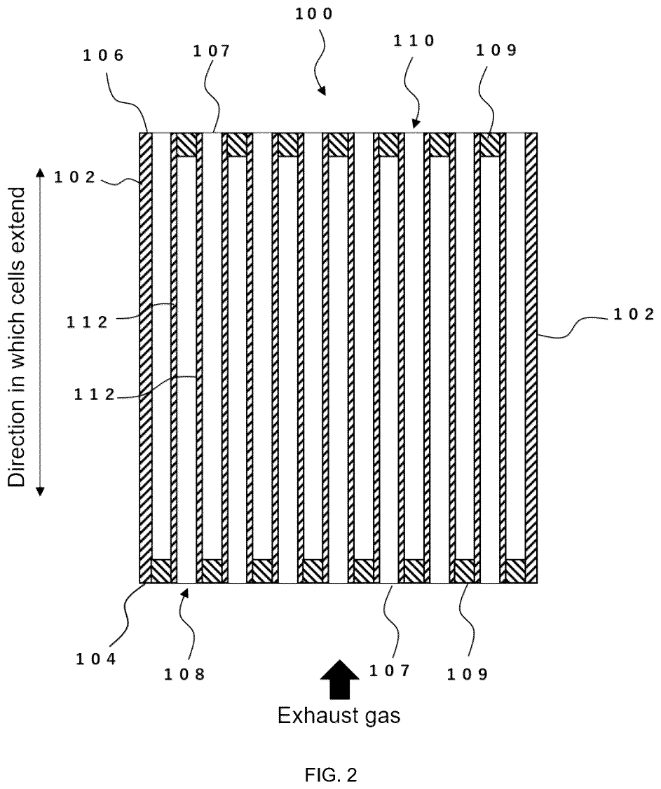

FIGS. 1 and 2 are a schematic perspective view and a cross-sectional view, respectively, of a pillar-shaped honeycomb structure 100 that can be used as a wall-flow type exhaust gas filter for automobiles. The honeycomb structure 100 comprises: an outer peripheral side wall 102; a plurality of inlet cells 108 arranged on the inner peripheral side of the outer peripheral side wall 102, extending from an inlet end surface 104 to an outlet end surface 106 in parallel, having an opening 107 at the inlet end surface 104, and having a sealing portion 109 at the outlet end surface 106; and a plurality of outlet cells 110 arranged on the inner peripheral side of the outer peripheral side wall 102, extending from the inlet end surface 104 to the outlet end surface 106 in parallel, having a sealing portion 109 at the inlet end surface, and having an opening 107 at the outlet end surface 106.

In this honeycomb structure 100, at least a part of the plurality of inlet cells 108 are adjacent to at least a part of the plurality of outlet cells 110 with each of partition walls 112 interposed therebetween. When the inlet cell 108 and the outlet cell 110 are adjacent to each other with the partition wall 112 therebetween, the surface of the partition wall 112 contributes to filtration. For example, when exhaust gas containing particulate matter such as soot is supplied to the upstream inlet end surface 104 of the honeycomb structure 100, the exhaust gas is introduced into the inlet cell 108 and travels downstream within the inlet cells 108. Since the inlet cell 108 is sealed at the outlet end surface 106 on the downstream side, the exhaust gas passes through the partition wall located between the adjacent inlet cell 108 and outlet cell 110 and flows into the outlet cell 110. Since the particulate matter cannot pass through the partition wall 112, it is captured and deposited in the inlet cell 108. After the particulate matter has been removed, the clean exhaust gas that has flowed into the outlet cell 110 advances downstream within the outlet cell 110 and flows out from the outlet end surface 106 on the downstream side.

In a preferred embodiment, at least one outlet cell 110 of the plurality of outlet cells 110 is adjacent only to an inlet cell 108 (that is, adjacent neither to another outlet cell 110 nor to the outer peripheral side wall 102). This is because the outlet cells 110 exhibit a filtering function by being adjacent to the inlet cell 108. It is also preferable that none of the plurality of outlet cells 110 is not adjacent to each other.

The shape of the end surface of the honeycomb structure 100 is not limited, and may be, for example, a round shape such as a circle, an ellipse, a racetrack shape, or a long circle shape, a polygonal shape such as a triangle or a quadrangle, or other irregular shape. The illustrated honeycomb structure 100 has a circular shape of the end surface and is cylindrical as a whole.

There is no particular limitation on the height of the honeycomb structure (the length from the inlet end surface to the outlet end surface), and it may be appropriately set depending on the application and required performance. The height of the honeycomb structure may be, for example, 40 to 450 mm, preferably 60 to 400 mm, and more preferably 100 to 330 mm. There is no particular limitation on the relationship between the height of the honeycomb structure and the maximum diameter of each end surface (the maximum length of the diameters passing through the center of gravity of each end surface of the honeycomb structure). Therefore, the height of the honeycomb structure may be longer than the maximum diameter of each end surface, or the height of the honeycomb structure may be shorter than the maximum diameter of each end surface.

The shape of the opening of the inlet cell is not particularly limited. For example, in the cross section orthogonal to the direction in which the cells of the honeycomb structure extend, the shape can be a polygon (a quadrangle (rectangle, square), pentagon, hexagon, heptagon, octagon, and the like), a round shape (a circle, an ellipse, an oval, an egg shape, an elongated circular shape, and the like), and the like. These shapes may be adopted alone or in combination of two or more. Among these, for the reason of reducing pressure loss, it is preferable that the opening shape of each of the plurality of inlet cells, except for those adjacent to the outer peripheral side wall 102, is all hexagonal or octagonal, and it is more preferable that it is octagonal. When the opening shape of the inlet cell 108 and the outlet cell 110 is polygonal, the corners may be rounded. As used herein, even if the corners are rounded, they are treated as polygonal.

The opening shape of the outlet cell 110 is not particularly limited either, and may be set to match the opening shape of the inlet cell 108. For example, when the opening shape of the inlet cell 108 is octagonal, it is preferable to set the opening shape of the outlet cell 110 to a quadrangle.

### (1-2) Specific Structure

The present inventors have found two suitable combinations of parameters related to the specific structure of a honeycomb structure, such as the cell density, the average thickness of the partition walls, the opening diameter ratio, and the average porosity of the partition walls. Therefore, they will be described separately as a first embodiment and a second embodiment.

### A. First Embodiment

### (A1) Cell Density

The cell density is an index representing the number of cells per unit area when the honeycomb structure is observed from the inlet end surface or the outlet end surface. It is desirable to make the cell density smaller than the value conventionally adopted for DPFs in order to increase the pressure loss gradient. However, simply reducing the cell density reduces the heat capacity of the honeycomb structure, which may cause the honeycomb structure to become hot during filter regeneration and may be damaged. For this reason, it is not desirable to reduce the cell density excessively, since this will result in a decrease in the soot accumulation limit. Therefore, the cell density based on the total number of the plurality of inlet cells 108 and the plurality of outlet cells 110 is preferably 29 to 43 cells/cm², more preferably 30 to 40 cells/cm², and even more preferably 31 to 39 cells/cm². The cell density is calculated by dividing the total number of the plurality of inlet cells 108 and the plurality of outlet cells 110 (including sealed cells, outlet cells 110 adjacent to the peripheral sidewall 102, and inlet cells 108 adjacent to the peripheral sidewall 102) by the area of one end face of the honeycomb structure 100 excluding the outer peripheral sidewall 102.

### (A2) Average Thickness of Partition Walls

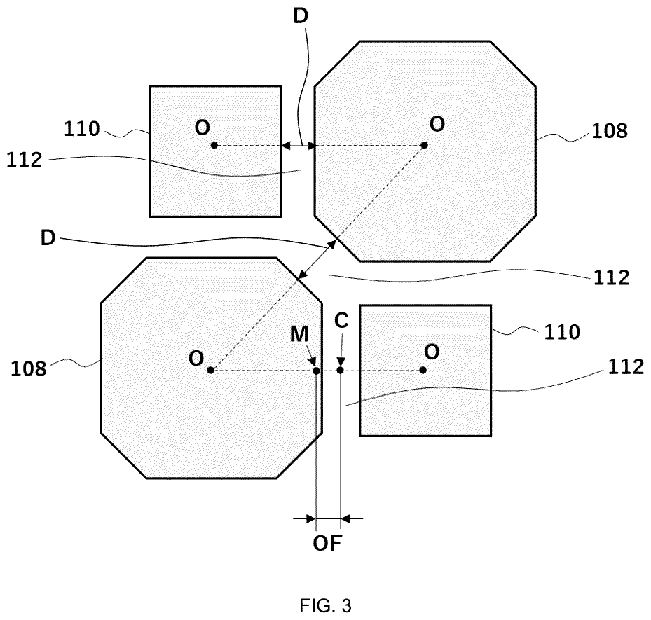

From the viewpoint of ensuring the strength of the honeycomb structure and increasing the soot accumulation limit amount by ensuring the heat capacity of the honeycomb structure while satisfying the above-mentioned predetermined cell density, the average thickness of the partition walls 112 is preferably 0.173 mm or more and 0.236 mm or less, more preferably 0.198 mm or more and 0.229 mm or less, and even more preferably 0.203 mm or more and 0.216 mm or less. FIG. 3 shows a schematic enlarged partial view of the partition walls 112 of a honeycomb structure 100 in which the opening shape of the inlet cells 108 is octagonal and the opening shape of the outlet cells 110 is quadrangle, observed at a cross section orthogonal to the direction in which the cells extend. The thickness of the partition wall refers to a crossing length D of a line segment that crosses the partition wall when the centers of gravity O of adjacent cells are connected by this line segment in a cross-section orthogonal to the direction in which the cells extend (the height direction of the honeycomb structure). The average thickness of the partition walls 112 is calculated based on the thicknesses of all the partition walls 112.

In addition, “two cells are adjacent to each other with a partition wall interposed therebetween” means that when the partition wall of the honeycomb structure is observed from the cross section orthogonal to the direction in which the cells extend, the two cells are adjacent to each other with opposing wall surfaces of a single partition wall (sides of the polygon that defines the cells) between them, but does not include cases where the two cells are adjacent to each other with vertices of the polygons that define the two cells interposed therebetween.

$$( A 3 ) Opening diameter ratio ( {D}_{i n} / {D}_{out} )$$

From the viewpoint of minimizing the pressure loss after PM accumulation while increasing the pressure loss gradient, assuming the average value of opening diameters of the plurality of outlet cells except for those adjacent to the outer peripheral side wall is Dₒᵤₜ, and the average value of opening diameters of the plurality of inlet cells except for those adjacent to the outer peripheral side wall is Dᵢₙ, it is preferable that 1.20≤Dᵢₙ/Dₒᵤₜ≤1.38 be satisfied, more preferable that 1.22≤Dᵢₙ/Dₒᵤₜ≤1.29 be satisfied, and even more preferable that 1.25≤Dᵢₙ/Dₒᵤₜ≤1.28 be satisfied.

The opening diameter of each of the plurality of inlet cells is defined as a circle equivalent diameter calculated based on the opening area of the corresponding inlet cell. The average value Dᵢₙ is calculated based on the opening diameters of all the plurality of inlet cells except for those adjacent to the outer peripheral side wall.

The opening diameter of each of the plurality of outlet cells is defined as a circle equivalent diameter calculated based on the opening area of the corresponding outlet cell. The average value Dₒᵤₜ is calculated based on the opening diameters of all the plurality of outlet cells except for those adjacent to the outer peripheral side wall.

### (A4) Opening Diameter

From the viewpoint of suppressing the initial pressure loss and preventing the pressure loss after accumulation of PM from becoming excessively large, the average value Dᵢₙ of the opening diameters of each of the plurality of inlet cells, except for those adjacent to the outer peripheral side wall, is preferably 1.48 mm or more and 1.80 mm or less, more preferably 1.50 to 1.79 mm, and even more preferably 1.54 to 1.75 mm. In addition, the average opening diameter Dₒᵤₜ of each of the plurality of outlet cells, except for those adjacent to the outer peripheral side wall, is preferably 1.16 mm or more and 1.48 mm or less, more preferably 1.18 to 1.43 mm, and even more preferably 1.22 to 1.39 mm.

### (A5) Average Porosity of Partition Walls

From the viewpoint of reducing pressure loss, the partition walls preferably have a lower limit of the average porosity of 52% or more, more preferably 53% or more. In addition, from the viewpoint of increasing the mechanical strength of the honeycomb structure, the partition walls preferably have an upper limit of the average porosity of 60% or less, and more preferably 58% or less. Therefore, the partition walls preferably have an average porosity of, for example, 52 to 60%, and more preferably 53 to 58%. As used herein, the porosity is measured by the mercury porosimetry in accordance with JIS R1655: 2003. In addition, the average porosity is determined by taking partition wall samples (0.3 g each) from six locations of the honeycomb structure without bias, and measuring the porosity of each sample, and the average value is regarded as the measured value.

### (A6) Ratio of the Number of Inlet Cells to the Number of Outlet Cells

From the viewpoint of increasing the pressure loss gradient while suppressing an increase in pressure loss, the ratio of the number of the plurality of inlet cells to the number of the plurality of outlet cells is preferably 0.9 to 1.1, more preferably 0.95 to 1.05, even more preferably 0.99 to 1.01, and most preferably 1. It should be noted that when calculating the ratio of the number of inlet cells to the number of outlet cells, the outlet cells adjacent to the outer peripheral side wall and the inlet cells adjacent to the outer peripheral side wall are not counted.

### B. Second Embodiment

### (B1) Cell Density

The cell density is an index representing the number of cells per unit area when the honeycomb structure is observed from the inlet end surface or the outlet end surface. It is desirable to make the cell density smaller than the value conventionally adopted for DPFs in order to increase the pressure loss gradient. However, simply reducing the cell density reduces the heat capacity of the honeycomb structure, which may cause the honeycomb structure to become hot during filter regeneration and may be damaged. For this reason, it is not desirable to reduce the cell density excessively, since this will result in a decrease in the soot accumulation limit. Therefore, the cell density based on the total number of the plurality of inlet cells 108 and the plurality of outlet cells 110 is preferably 29 to 36 cells/cm², more preferably 30 to 34 cells/cm², and even more preferably 31 to 33 cells/cm². The cell density is calculated by dividing the total number of the plurality of inlet cells 108 and the plurality of outlet cells 110 (including sealed cells, outlet cells 110 adjacent to the peripheral sidewall 102, and inlet cells 108 adjacent to the peripheral sidewall 102) by the area of one end face of the honeycomb structure 100 excluding the outer peripheral sidewall 102.

### (B2) Average Thickness of Partition Walls

From the viewpoint of ensuring the strength of the honeycomb structure and increasing the soot accumulation limit amount by ensuring the heat capacity of the honeycomb structure while satisfying the above-mentioned predetermined cell density, the average thickness of the partition walls 112 is preferably 0.231 mm or more and 0.312 mm or less, more preferably 0.241 mm or more and 0.292 mm or less, and even more preferably 0.254 mm or more and 0.279 mm or less. FIG. 3 shows a schematic enlarged partial view of the partition walls 112 of a honeycomb structure 100 in which the opening shape of the inlet cells 108 is octagonal and the opening shape of the outlet cells 110 is quadrangle, observed at a cross section orthogonal to the direction in which the cells extend. The thickness of the partition wall refers to a crossing length D of a line segment that crosses the partition wall when the centers of gravity O of adjacent cells are connected by this line segment in a cross-section orthogonal to the direction in which the cells extend (the height direction of the honeycomb structure). The average thickness of the partition walls 112 is calculated based on the thicknesses of all the partition walls 112.

In addition, “two cells are adjacent to each other with a partition wall interposed therebetween” means that when the partition wall of the honeycomb structure is observed from the cross section orthogonal to the direction in which the cells extend, the two cells are adjacent to each other with opposing wall surfaces of a single partition wall (sides of the polygon that defines the cells) between them, but does not include cases where the two cells are adjacent to each other with vertices of the polygons that define the two cells interposed therebetween.

$$( B 3 ) Opening diameter ratio ( {D}_{i n} / {D}_{out} )$$

From the viewpoint of minimizing the pressure loss after PM accumulation while increasing the pressure loss gradient, assuming the average value of opening diameters of the plurality of outlet cells except for those adjacent to the outer peripheral side wall is Dₒᵤₜ, and the average value of opening diameters of the plurality of inlet cells except for those adjacent to the outer peripheral side wall is Dᵢₙ, it is preferable that 1.14≤Dᵢₙ/Dₒᵤₜ≤1.37 be satisfied, more preferable that 1.22≤Dᵢₙ/Dₒᵤₜ≤1.27 be satisfied, and even more preferable that 1.23≤Dᵢₙ/Dₒᵤₜ≤1.24 be satisfied.

The opening diameter of each of the plurality of inlet cells is defined as a circle equivalent diameter calculated based on the opening area of the corresponding inlet cell. The average value Dᵢₙ is calculated based on the opening diameters of all the plurality of inlet cells except for those adjacent to the outer peripheral side wall.

The opening diameter of each of the plurality of outlet cells is defined as a circle equivalent diameter calculated based on the opening area of the corresponding outlet cell. The average value Dₒᵤₜ is calculated based on the opening diameters of all the plurality of outlet cells except for those adjacent to the outer peripheral side wall.

### (B4) Opening Diameter

From the viewpoint of suppressing the initial pressure loss and preventing the pressure loss after accumulation of PM from becoming excessively large, the average value Dᵢₙ of the opening diameters of each of the plurality of inlet cells, except for those adjacent to the outer peripheral side wall, is preferably 1.52 mm or more and 1.76 mm or less, more preferably 1.63 to 1.73 mm, and even more preferably 1.64 to 1.69 mm. In addition, the average opening diameter Dₒᵤₜ of each of the plurality of outlet cells, except for those adjacent to the outer peripheral side wall, is preferably 1.20 mm or more and 1.44 mm or less, more preferably 1.31 to 1.43 mm, and even more preferably 1.35 to 1.41 mm.

### (B5) Average Porosity of Partition Walls

From the viewpoint of reducing pressure loss, the partition walls preferably have a lower limit of the average porosity of 57% or more, more preferably 58% or more. In addition, from the viewpoint of increasing the mechanical strength of the honeycomb structure, the partition walls preferably have an upper limit of the average porosity of 63% or less, and more preferably 61% or less. Therefore, the partition walls preferably have an average porosity of, for example, 57 to 63%, and more preferably 58 to 61%. As used herein, the porosity is measured by the mercury porosimetry in accordance with JIS R1655: 2003. In addition, the average porosity is determined by taking partition wall samples (0.3 g each) from six locations of the honeycomb structure without bias, and measuring the porosity of each sample, and the average value is regarded as the measured value.

### (B6) Ratio of the Number of Inlet Cells to the Number of Outlet Cells

From the viewpoint of increasing the pressure loss gradient while suppressing an increase in pressure loss, the ratio of the number of the plurality of inlet cells to the number of the plurality of outlet cells is preferably 0.9 to 1.1, more preferably 0.95 to 1.05, even more preferably 0.99 to 1.01, and most preferably 1. It should be noted that when calculating the ratio of the number of inlet cells to the number of outlet cells, the outlet cells adjacent to the outer peripheral side wall and the inlet cells adjacent to the outer peripheral side wall are not counted.

### (B7) Average Pore Diameter

From the viewpoint of pressure loss after soot deposition, the average pore diameter of the partition walls 112 is preferably 13 μm or less, and more preferably 11 μm or less. In addition, from the viewpoint of pressure loss without soot deposition, the average pore diameter of the partition walls 112 is preferably 7 μm or more, and more preferably 9 μm or more. Therefore, the average pore diameter of the partition walls 112 is preferably, for example, 7 to 13 μm, and more preferably 9 to 11 μm. The average pore diameter of the partition walls is measured by mercury intrusion porosimetry in accordance with JIS R1655: 2003. 20 partition wall test pieces are taken evenly from locations including the center and the outer periphery of the honeycomb structure, and the average pore diameter of each test piece is measured, and the average value is regarded as the average pore diameter of the entire honeycomb structure.

### (1-3) Density

From the viewpoint of suppressing the temperature rise during filter regeneration and increasing the soot accumulation limit, it is preferable that the honeycomb structure have a large mass per volume, that is, a large density. Since a large density increases the heat capacity, it is possible to suppress the temperature rise. The density referred to here is a value calculated based on the volume measured from the outer dimensions of the honeycomb structure, and does not take into account the internal cell structure or pores. Specifically, the lower limit of the density of the honeycomb structure is preferably 0.288 g/cm³ or more, more preferably 0.291 g/cm³ or more, and further preferably 0.294 g/cm³ or more. There is no particular upper limit to the density of the honeycomb structure, but from the viewpoint of ease of production taking into account the above-mentioned cell structure and materials, it is preferable that the density be 0.410 g/cm³ or less, more preferably 0.382 g/cm³ or less, and even more preferably 0.381 g/cm³ or less. Therefore, the density of the honeycomb structure is, for example, preferably 0.288 to 0.410 g/cm³, more preferably 0.291 to 0.382 g/cm³, and even more preferably 0.294 to 0.381 g/cm³.

### (1-4) Pressure Loss Gradient

When the amount of change in pressure loss (pressure loss gradient) corresponding to the amount of PM accumulated in the honeycomb structure is large, it becomes easier for the pressure sensor to detect the amount of PM accumulation suitable for filter regeneration or cleaning treatment.

Specifically, when a deposition mass of particulate matter comprising soot per unit volume of the honeycomb structure is 1 g/L, assuming the pressure loss when exhaust gas having a temperature of 250° C. and a flow rate of 480 kg/hr passes from the inlet end surface to the outlet end surface is defined as P₁, and
when a deposition mass of particulate matter comprising soot per unit volume of the honeycomb structure is 3 g/L, assuming the pressure loss when exhaust gas having a temperature of 250° C. and a flow rate of 480 kg/hr passes from the inlet end surface to the outlet end surface is defined as P₂,
it is preferable that 45%≤(P₂−P₁)/P₁ be satisfied, more preferable that 47%≤(P₂−P₁)/P₁ be satisfied, and even more preferable that 48%≤(P₂−P₁)/P₁ be satisfied.

In addition, from the viewpoint of suppressing an excessive increase in pressure loss and ensuring practical use as a filter, it is preferable that (P₂−P₁)/P₁≤66% be satisfied, is more preferable that (P₂−P₁)/P₁≤63% be satisfied, and even more preferable that (P₂−P₁)/P₁≤61% be satisfied.

Therefore, the pressure loss gradient of the honeycomb structure preferably satisfies, for example, 45%≤(P₂−P₁)/P₁≤66%, more preferably 47%≤(P₂−P₁)/P₁≤63%, and even more preferably 48%≤(P₂−P₁)/P₁≤61%.

From the viewpoint of suppressing an excessive increase in pressure loss and ensuring practicality as a filter, the upper limit of P₂ is preferably less than 3.69 kPa, more preferably 3.67 kPa or less, and even more preferably 3.65 kPa or less. From the viewpoint of increasing the pressure loss gradient, the lower limit of P₂ is preferably 3.21 kPa or more, more preferably 3.49 kPa or more, and even more preferably 3.57 kPa or more.

### (1-5) Material

From the viewpoint of obtaining excellent thermal shock resistance, at least the partition walls of the honeycomb structure, preferably the outer peripheral side wall and the partition walls, and more preferably the outer peripheral side wall, the partition walls and the sealing portions comprise one or more selected from cordierite, silicon carbide, a silicon-silicon carbide composite material, silicon nitride, mullite, alumina and aluminum titanate.

The outer peripheral side wall, the partition walls and the sealing portions of the honeycomb structure may comprise ceramics other than those mentioned above. Other ceramics include, for example, zirconium phosphate, cordierite-silicon carbide composite, zirconia, spinel, indialite, sapphirine, corundum, titania, and ceria. Furthermore, as such other ceramics, one type may be contained alone, or two or more types may be contained in combination.

When the honeycomb structure comprises cordierite as its main component, the partition walls of the honeycomb structure, preferably the outer peripheral side wall and the partition walls, and more preferably the outer peripheral side walls, the partition walls and the sealing portions, have a lower limit of the cordierite content of preferably 90% by mass or more, more preferably 91% by mass or more, and even more preferably 92% by mass or more. Although there is no particular upper limit, from the viewpoint of modifying the properties of the honeycomb structure by adding other ceramics, the partition walls of the honeycomb structure, preferably the outer peripheral side wall and the partition walls, and more preferably the outer peripheral side walls, the partition walls and the sealing portions, have an upper limit of the cordierite content of preferably 96% by mass or less, more preferably 95% by mass or less, and further more preferably 94% by mass or less. Therefore, when the honeycomb structure is mainly composed of cordierite, the partition walls of the honeycomb structure, preferably the outer peripheral side wall and the partition walls, and more preferably the outer peripheral side walls, the partition walls and the sealing portions, have a cordierite content of, for example, preferably 90 to 96% by mass, more preferably 91 to 95% by mass, and even more preferably 92 to 94% by mass.

The cordierite content can be measured by X-ray diffraction. Specifically, an X-ray diffraction apparatus using Cu Kαradiation (for example, X′pert PRO apparatus manufactured by Malvern Panalytical Ltd) is used to perform X-ray analysis measurement in the range of 2θ=8 to 100° by X-ray diffraction on a sample of the outer peripheral side wall, the partition wall, or the sealing portion, and analysis is performed using the Rietveld analysis program RIETAN to measure the crystalline phase ratio of cordierite, which is defined as the cordierite content.

The honeycomb structure may be a honeycomb joined body having a plurality of honeycomb segments and a joining layer joining the outer peripheral surfaces of the plurality of honeycomb segments together. By using a honeycomb joined body, it is possible to increase the total cross-sectional area of the cells, which is important for ensuring the flow rate of air, while suppressing the occurrence of cracks. The joining layer can be formed by using a joining material. The joining material is not particularly limited, and may be a ceramic material with a solvent such as water added thereto to form a paste. The joining material may contain the same material as the partition walls. In addition to joining the honeycomb segments together, the joining material may also be used as an outer periphery coating material after joining the honeycomb segments.

In one embodiment, the sealing portions at both the inlet and outlet end surfaces have an average sealing portion depth of 2 to 8 mm. When the average depth of the sealing portions is 2 mm or more, the strength of the sealing portions can be ensured. The average depth of the sealing portions is preferably 3 mm or more. In addition, by making the average depth of the sealing portions 8 mm or less, it is possible to prevent the area of the partition walls that collects particulate matter in the cells from becoming small. The average depth of the sealing portions is preferably 7 mm or less. The depth of the sealing portions in the direction in which the cells extend is measured at 20 random locations on each end surface, and the average value is regarded as the average depth of the sealing portions on each end surface. The depth of each sealing portion means the length in the direction in which the cells extend from the position of the inlet end surface or outlet end surface where the sealing portion is formed to the deepest position where the sealing portion exists.

The honeycomb structure can also be used as a catalyst carrier. A catalyst can be carried on the surface of the partition walls according to the purpose. The catalyst is preferably carried within the inlet cells. As to the catalyst, although not limited, mention can be made to a diesel oxidation catalyst (DOC) for oxidizing and burning hydrocarbons (HC) and carbon monoxide (CO) to increase exhaust gas temperature, a PM combustion catalyst that assists in the combustion of PM such as soot, an SCR catalyst and an NSR catalyst that remove nitrogen oxides (NOx), as well as a three-way catalyst that can simultaneously remove hydrocarbons (HC), carbon monoxide (CO), and nitrogen oxides (NOx). The catalyst may contain as appropriate, for example, noble metals (Pt, Pd, Rh, and the like), alkali metals (Li, Na, K, Cs, and the like), alkaline earth metals (Mg, Ca, Ba, Sr, and the like), rare earths (Ce, Sm, Gd, Nd, Y, La, Pr, and the like), transition metals (Mn, Fe, Co, Ni, Cu, Zn, Sc, Ti, Zr, V, Cr, and the like), and the like.

### 2. MANUFACTURING METHOD OF HONEYCOMB STRUCTURE

A method for manufacturing a pillar-shaped honeycomb structure according to one embodiment of the present invention will be described below by way of example. First, a raw material composition containing a cordierite-forming raw material, a pore-forming material, a dispersion medium, and a binder is kneaded to form a green body, and then the green body is extrusion molded to obtain a pillar-shaped honeycomb formed body having an outer peripheral side wall, and a plurality of cells disposed on the inner peripheral side of the outer peripheral side wall, extending from the inlet end surface to the outlet end surface, in which both the inlet end surface and the outlet end surface have openings. The raw material composition may contain additives such as a dispersant or other ceramic raw materials, as necessary. In extrusion molding, a die having a desired overall shape, cell shape, cell arrangement, partition wall thickness, cell density, and the like can be used.

The cordierite-forming raw material is a raw material that becomes cordierite when fired, and can be provided, for example, in the form of a powder. It is desirable that the cordierite-forming raw material have a chemical composition of alumina (Al₂O₃) (including aluminum hydroxide that converts to alumina): 30 to 45% by mass, magnesia (MgO): 11 to 17% by mass, and silica (SiO2): 42 to 57% by mass.

The dispersion medium may be water or a mixed solvent of water and an organic solvent such as alcohol, and water is particularly preferred.

The content of the dispersion medium in the honeycomb formed body before a drying process is carried out is preferably 20 to 110 parts by mass, more preferably 25 to 100 parts by mass, and even more preferably 30 to 90 parts by mass, with respect to 100 parts by mass of the cordierite-forming raw material. When the content of the dispersion medium in the honeycomb formed body is 20 parts by mass or more with respect to 100 parts by mass of the cordierite-forming raw material, the quality of the honeycomb structure is likely to be stable. When the content of the dispersion medium in the honeycomb formed body is 90 parts by mass or less with respect to 100 parts by mass of the cordierite-forming raw material, the amount of shrinkage during drying is small, and deformation can be suppressed. As used herein, the content of the dispersion medium in the honeycomb formed body refers to a value measured by a loss on drying method.

The pore-forming material is not particularly limited as long as it becomes pores after firing, and examples thereof include wheat flour, starch, foamed resin, water-absorbent resin, silica gel, carbon (for example, graphite), ceramic balloons, polyethylene, polystyrene, polypropylene, nylon, polyester, acrylic resin, phenol, and the like. As the pore-forming material, one type may be used alone, or two or more types may be used in combination. From the viewpoint of increasing the porosity of the honeycomb structure after firing, the content of the pore-forming material is preferably 3 part by mass or more, more preferably 6 parts by mass or more, and even more preferably 9 parts by mass or more, with respect to 100 parts by mass of the cordierite-forming raw material. From the viewpoint of ensuring the strength of the honeycomb structure after firing, the content of the pore-forming material is preferably 30 parts by mass or less, more preferably 27 parts by mass or less, and even more preferably 24 parts by mass or less, with respect to 100 parts by mass of the cordierite-forming raw material.

As the binder, examples include organic binders such as methyl cellulose, hydroxypropoxyl methyl cellulose, hydroxypropyl methyl cellulose, hydroxyethyl cellulose, hydroxyethyl methyl cellulose, carboxymethyl cellulose, and polyvinyl alcohol. Further, from the viewpoint of increasing the strength of the honeycomb formed body before firing, the content of the binder is preferably 4 parts by mass or more, more preferably 4.5 parts by mass or more, and even more preferably 5 parts by mass or more, with respect to 100 parts by mass of the cordierite-forming raw material. From the viewpoint of suppressing the occurrence of cracks due to abnormal heat generation in the firing step, the content of the binder is preferably 9 parts by mass or less, more preferably 8 parts by mass or less, and even more preferably 7 parts by mass or less, with respect to 100 parts by mass of the cordierite-forming raw material. As the binder, one type may be used alone, and two or more types may be used in combination.

As the dispersant, ethylene glycol, dextrin, fatty acid soap, polyether polyol, and the like can be used. As the dispersant, one type may be used alone, and two or more types may be used in combination. The content of the dispersant is preferably 0 to 2 parts by mass with respect to 100 parts by mass of the cordierite-forming raw material.

For drying of honeycomb formed body, conventionally known drying methods such as hot gas drying, microwave drying, dielectric drying, reduced pressure drying, vacuum drying, and freeze drying can be used. Among these, a drying method that combines hot gas drying with microwave drying or dielectric drying is preferable since the entire honeycomb formed body can be dried quickly and uniformly.

After drying the honeycomb formed body, sealing portions are formed on both end surfaces of the honeycomb formed body. Each sealing portion can be formed by filling the openings of the inlet cells and outlet cells where the sealing portions are to be formed with a sealing portion forming slurry, and then drying and firing the filled slurry. The sealing portion forming slurry can be made of the material of the honeycomb formed body. For example, without being limited thereto, when the honeycomb formed body contains a cordierite-forming raw material, a pore forming material, a dispersion medium, and a binder, the sealing portion forming slurry can contain the cordierite-forming raw material, the pore forming material, the dispersion medium, and a binder.

For example, the sealing portion forming slurry contains 30 to 60 parts by mass of the dispersion medium, 5 to 20 parts by mass of the pore-forming material, and 0.2 to 2.0 parts by mass of the binder, with respect to 100 parts by mass of the cordierite-forming raw material. In a preferred embodiment, the sealing portion forming slurry contains 35 to 50 parts by mass of the dispersion medium, 8 to 16 parts by mass of the pore-forming material, and 0.2 to 1.5 parts by mass of the binder, with respect to 100 parts by mass of the cordierite-forming raw material.

The dispersion medium may be water or a mixed solvent of water and an organic solvent such as alcohol, and water is particularly preferred.

The pore-forming material is not particularly limited as long as it becomes pores after firing, and examples thereof include wheat flour, starch, foamed resin, water-absorbent resin, silica gel, carbon (for example, graphite), ceramic balloons, polyethylene, polystyrene, polypropylene, nylon, polyester, acrylic resin, phenol, and the like. As the pore-forming material, one type may be used alone, or two or more types may be used in combination.

As the binder, examples include organic binders such as methyl cellulose, hydroxypropoxyl methyl cellulose, hydroxypropyl methyl cellulose, hydroxyethyl cellulose, hydroxyethyl methyl cellulose, carboxymethyl cellulose, and polyvinyl alcohol. As the binder, one type may be used alone, and two or more types may be used in combination.

The sealing portion forming slurry may contain a dispersant as appropriate. Examples of the dispersant include ethylene glycol, dextrin, fatty acid soap, polyalcohol, and the like. As the dispersant, one type may be used alone, or two or more types may be used in combination.

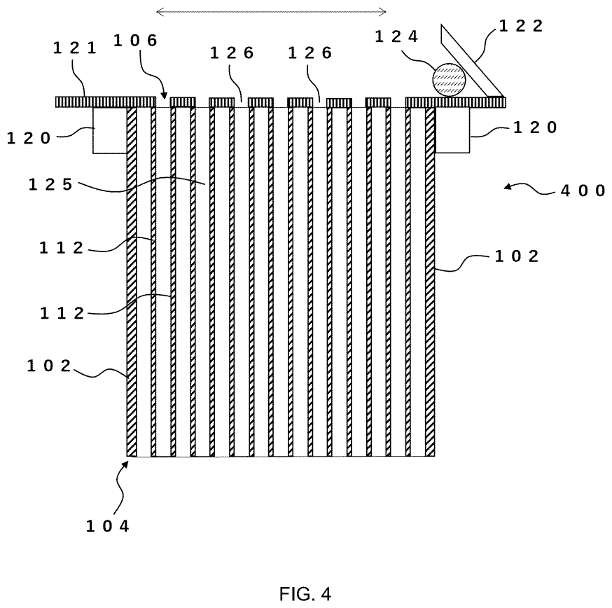

The openings of the cells can be filled with the sealing portion forming slurry by, for example, the following “squeegee method.” As shown in FIG. 4, a film 121 is attached to the upper end surface (here, the outlet end surface 106 in the figure) of the dried honeycomb formed body 400 fixed by a chuck 120, and a laser is irradiated onto the film 121 at positions corresponding to the arrangement conditions of the sealing portions, thereby drilling a plurality of holes 126 in the film 121.

Thereafter, a sealing portion forming slurry 124 is placed on the film 121, and a squeegee 122 is moved along the film 121 in the direction of the arrow in FIG. 4. As a result, a certain amount of sealing portion forming slurry 124 is filled into cells 125 that are open at positions corresponding to the holes 126 of the film 121.

The depth of the sealing portion can be changed by the number of times the squeegee 122 is moved, the contact angle between the squeegee 122 and the film 121, the pressing pressure of the squeegee 122 against the film 121, and the viscosity of the sealing portion forming slurry 124, and the like.

After filling the sealing portion forming slurry 124, the film 121 is peeled off, and the entire honeycomb formed body 400 is dried. Through this drying process, the sealing portion forming slurry 124 filled in the cells 125 is dried, and the sealing portions before firing are formed. Drying can be performed, for example, under conditions of a drying temperature of 100 to 230° C. for about 60 to 150 seconds. After drying, the sealing portions protrude from the end surfaces of the honeycomb formed body by the thickness of the film, and can be scraped off as necessary.

The material of the film is not particularly limited, but is preferably polypropylene (PP), polyethylene terephthalate (PET), polyimide, or Teflon (registered trademark), since these materials are easily heat-processed to form holes. The film preferably has an adhesive layer, and the material of the adhesive layer is preferably an acrylic resin, a rubber-based material (for example, a rubber whose main component is natural rubber or synthetic rubber), or a silicone-based resin. The film may be, for example, an adhesive film having a thickness of 20 to 50 μm.

Besides the above-mentioned “squeegee method”, another method for filling the openings of the cells with the sealing portion forming slurry is the “pressure-in method.” The “press-in method” is a method in which an end surface of a honeycomb formed body with a film attached and holes drilled therein is immersed in a liquid tank containing a sealing portion forming slurry, and the cells are filled with the sealing portion forming slurry. In this case, the depth of the sealing portions can be changed by changing the depth to which the honeycomb formed body is immersed in the sealing portion forming slurry.

The honeycomb formed body filled with the sealing portion forming slurry is then subjected to a degreasing step and a firing step, thereby manufacturing a honeycomb structure. The combustion temperature of the binder is about 200° C., and the combustion temperature of the pore-forming material is about 300 to 1000° C. Therefore, the degreasing step may be carried out by heating the honeycomb formed body to a range of about 200 to 1000° C. The heating time is not particularly limited, but is usually about 10 to 100 hours. The honeycomb formed body after the degreasing process is called a calcined body. The firing process depends on the material composition of the honeycomb structure, but can be carried out, for example, by heating the calcined body to 1300 to 1450° C. and holding it for 3 to 24 hours.

A catalyst can be carried on the partition walls of the honeycomb structure thus manufactured. One example of a method for carrying a catalyst on the partition walls includes introducing a catalyst slurry into the cells by a conventionally known suction method or the like, for allowing it to adhere to the surfaces and pores of the partition walls, and then subjecting it to a high-temperature treatment is performed to bake the catalyst contained in the catalyst slurry onto the partition walls. The types of catalyst are as exemplified above.

### EXAMPLES

Hereinafter, the following examples are provided to better understand the present invention and its advantages, but the present invention is not limited to these examples.

### A. First Embodiment

### A1. Manufacture of Honeycomb Structure

### Honeycomb Structure Made of Cordierite: Examples 1-1 to 1-11, Comparative Examples 1-1 to 1-9

To 100 parts by mass of the cordierite-forming raw material, 0.5 parts by mass of a pore-forming material, 1 part by mass of a dispersion medium, and 6 parts by mass of an organic binder were added respectively, and they were mixed and kneaded to prepare a green body. The cordierite-forming raw material used was alumina, aluminum hydroxide, kaolin, talc, and silica, and the dispersion medium used was water. The organic binder used was methyl cellulose. The pore-forming used was a water-absorbent resin with a median diameter of 20 μm. Here, the median diameter of the raw material refers to the particle size at an integrated value of 50% (D50) in the particle size distribution obtained by a laser diffraction/scattering method.

Next, the green body was extrusion molded using a die for preparing a honeycomb formed body, to obtain a honeycomb formed body having an overall shape of a cylindrical shape. The structure of the die was changed depending on the test numbers.

Next, the honeycomb formed body was dried in a microwave dryer and further dried in a hot gas dryer, after which both end surfaces of the honeycomb formed body were cut to a predetermined size.

Next, a slurry for forming sealing portions was prepared using the same material as the honeycomb formed body. Thereafter, using this slurry, sealing portions were formed at the openings of the predetermined cells on the inlet end surface side and at the openings of the remaining cells on the outlet end surface side of the dried honeycomb formed body, such that the inlet cells and the outlet cells were alternately adjacent to each other.

Next, each of the honeycomb formed bodies after forming sealing portions was degreased and fired to produce a honeycomb structure according to each test number. The honeycomb structure thus obtained had a cylindrical shape with circular inlet and outlet end surfaces. The diameters of the inlet end surface and the outlet end surface were 228.6 mm. The length of the honeycomb structure in the direction in which the cells extend was 184.2 mm. The opening shape of the inlet cells was octagonal except for the one adjacent to the outer peripheral side wall. The shape of the openings of the outlet cells were square except for the one adjacent to the outer peripheral side wall. The average depth of the sealing portions at the inlet end surface and the outlet end surface was about 7 mm. A required number of the honeycomb structures to specify the following characteristics were prepared.

### A2. Structural Characteristics of Honeycomb Structure

Table 1 shows the structural characteristics of the honeycomb structures manufactured as above according to each test number.
Cell density
Average thickness of the partition walls
Average value Dᵢₙ of the opening diameters of the plurality of inlet cells except for those adjacent to the outer peripheral side wall
Average value Dₒᵤₜ of the opening diameters of the plurality of outlet cells except for those adjacent to the outer peripheral side wall

$$Opening diameter ratio ( {D}_{i n} / {D}_{out} )$$

Average porosity of partition walls.
Ratio of the number of inlet cells to the number of outlet cells
Density (mass of honeycomb structure/external dimensions)

The cell density means the cell density based on the total number of inlet cells and outlet cells, and was measured according to the method described above.

The average thickness of the partition walls was measured by observation with a scanning electron microscope (SEM) or by using a microscope.

The opening diameters of the inlet cell and the outlet cell were calculated by observation with a scanning electron microscope (SEM) or using a microscope.

The average value Dₒᵤₜ was calculated based on the opening diameters of all the outlet cells except for those adjacent to the outer peripheral side wall among the plurality of outlet cells.

The average value Dᵢₙ was calculated based on the opening diameters of all the inlet cells except for those adjacent to the outer peripheral side wall among the plurality of inlet cells.

The porosity of the partition walls was measured by the above-mentioned mercury intrusion method using Autopore 9500 (product name) manufactured by Micromeritics Instrument Corporation.

The ratio of the number of inlet cells to the number of outlet cells was calculated by visually counting the number of outlet cells and the number of inlet cells.

### A3. Functional Properties of Honeycomb Structure

The honeycomb structures according to the respective test numbers prepared above were used as exhaust gas filters, and the following characteristics were evaluated.

### Pressure Loss Characteristics

The exhaust gas filter was installed in the exhaust system of a diesel engine having a displacement of 13 liters, and a test was carried out in which soot was deposited on the filter. In addition, during soot accumulation, the fuel injection pressure was lowered to facilitate soot generation, and the engine was operated under low-temperature conditions, with the exhaust gas temperature at the filter inlet kept below 280° C., to prevent the soot from burning. The pressure loss (initial pressure loss) at the start of the test (before soot accumulation), the pressure loss (P₁) when the amount of soot accumulation (g) per 1 L of filter volume was 1 g/L, and the pressure loss (P₂) when the amount of soot accumulation (g) per 1 L of filter volume was 3 g/L were measured. When measuring the pressure loss, the engine output was increased, and the pressure loss was measured when exhaust gas with a temperature of 250° C. and a flow rate of 480 kg/hr passed from the inlet end surface of the filter to the outlet end surface. The results are shown in Table 1.

With Comparative Example 1, which is a representative example of a honeycomb structure according to the prior art, as a standard, the pass criteria for pressure loss characteristics were to satisfy all of the following:
The initial pressure loss is less than 1.17 kPa.
The pressure loss (P₁) is less than 2.61 kPa when the amount of soot deposition is 1 g/L.
The pressure loss (P₂) is less than 3.69 kPa when the amount of soot deposition is 3 g/L.
The index of pressure loss gradient, (P₂−P₁)/P₁, is 45% or more.

TABLE 1

| | | Partition | Inlet | Outlet | | Partition | | | | | | |
|---|---|---|---|---|---|---|---|---|---|---|---|---|
| | | wall | cell | cell | Opening | wall | Ratio of | | Initial | | | Pressure |
| | Cell | average | opening | opening | diameter | average | inlet cells | | pressure | | | loss |
| | density | thickness | diameter | diameter | ratio | porosity | number/outlet | Density | loss | P₁ | P₂ | gradient |
| Reference | #/cm² | mm | Dᵢₙ mm | Dₒᵤₜ mm | Dᵢₙ/Dₒᵤₜ | % | cells number | g/cm₃ | kPa | kPa | kPa | (P₂ − P₁)/P₁ |
| Comparative | 47 | 0.241 | 1.39 | 1.07 | 1.30 | 52 | 1.0 | 0.410 | 1.17 | 2.61 | 3.69 | 41% |
| Example 1-1 | | | | | | | | | | | | |
| Comparative | 37 | 0.165 | 1.63 | 1.31 | 1.24 | 52 | 1.0 | 0.282 | 0.72 | 2.03 | 3.19 | 57% |
| Example 1-2 | | | | | | | | | | | | |
| Comparative | 39 | 0.241 | 1.53 | 1.21 | 1.26 | 52 | 1.0 | 0.381 | 0.96 | 2.48 | 3.71 | 50% |
| Example 1-3 | | | | | | | | | | | | |
| Comparative | 31 | 0.241 | 1.71 | 1.39 | 1.23 | 52 | 1.0 | 0.348 | 0.78 | 2.43 | 3.89 | 60% |
| Example 1-4 | | | | | | | | | | | | |
| Comparative | 47 | 0.191 | 1.44 | 1.12 | 1.29 | 52 | 1.0 | 0.343 | 0.97 | 2.26 | 3.26 | 44% |
| Example 1-5 | | | | | | | | | | | | |
| Comparative | 45 | 0.229 | 1.42 | 1.10 | 1.29 | 52 | 1.0 | 0.388 | 1.08 | 2.49 | 3.58 | 44% |
| Example 1-6 | | | | | | | | | | | | |
| Comparative | 28 | 0.201 | 1.85 | 1.53 | 1.21 | 52 | 1.0 | 0.290 | 0.62 | 2.24 | 3.77 | 68% |
| Example 1-7 | | | | | | | | | | | | |
| Comparative | 40 | 0.229 | 1.59 | 1.11 | 1.43 | 52 | 1.0 | 0.366 | 1.08 | 2.56 | 3.69 | 44% |
| Example 1-8 | | | | | | | | | | | | |
| Comparative | 31 | 0.208 | 1.71 | 1.47 | 1.16 | 52 | 1.0 | 0.313 | 0.67 | 2.24 | 3.69 | 65% |
| Example 1-9 | | | | | | | | | | | | |
| Example 1-1 | 31 | 0.203 | 1.75 | 1.43 | 1.22 | 52 | 1.0 | 0.305 | 0.68 | 2.23 | 3.64 | 63% |
| Example 1-2 | 31 | 0.203 | 1.79 | 1.39 | 1.29 | 52 | 1.0 | 0.304 | 0.72 | 2.26 | 3.63 | 61% |
| Example 1-3 | 36 | 0.216 | 1.62 | 1.30 | 1.25 | 52 | 1.0 | 0.338 | 0.81 | 2.30 | 3.57 | 55% |
| Example 1-4 | 37 | 0.208 | 1.59 | 1.27 | 1.25 | 52 | 1.0 | 0.335 | 0.83 | 2.27 | 3.49 | 54% |
| Example 1-5 | 39 | 0.229 | 1.54 | 1.22 | 1.26 | 52 | 1.0 | 0.365 | 0.92 | 2.40 | 3.61 | 50% |
| Example 1-6 | 40 | 0.236 | 1.5 | 1.18 | 1.27 | 52 | 1.0 | 0.380 | 0.98 | 2.47 | 3.65 | 48% |
| Example 1-7 | 39 | 0.173 | 1.59 | 1.27 | 1.25 | 52 | 1.0 | 0.296 | 0.76 | 2.08 | 3.21 | 54% |
| Example 1-8 | 43 | 0.229 | 1.48 | 1.16 | 1.28 | 52 | 1.0 | 0.382 | 1.04 | 2.46 | 3.57 | 45% |
| Example 1-9 | 29 | 0.198 | 1.80 | 1.48 | 1.22 | 52 | 1.0 | 0.294 | 0.65 | 2.21 | 3.67 | 66% |
| Example 1-10 | 39 | 0.229 | 1.60 | 1.16 | 1.38 | 52 | 1.0 | 0.362 | 1.00 | 2.49 | 3.67 | 47% |
| Example 1-11 | 30 | 0.206 | 1.71 | 1.43 | 1.20 | 52 | 1.0 | 0.306 | 0.69 | 2.23 | 3.63 | 63% |

### Discussion

Comparative Example 1-1 to Comparative Example 1-9 did not have an appropriate combination of cell density, average thickness of partition walls, and opening diameter ratio. This resulted in excessively large pressure loss, a small pressure loss gradient, and a decrease in density (decreased heat capacity). In contrast, Examples 1-1 to 1-11 had an appropriate combination of cell density, average thickness of partition walls, and opening diameter ratio, so the initial pressure loss and pressure loss during soot accumulation were not excessively large, while a large pressure loss gradient was obtained. In addition, the heat capacity was practical in view of the density.

### B. Second Embodiment

### B1. Manufacture of Honeycomb Structure

### Honeycomb Structure Made of Cordierite: Examples 2-1 to 2-10, Comparative Examples 2-1 to 2-7

To 100 parts by mass of the cordierite-forming raw material, 0.5 parts by mass of a pore-forming material, 1 part by mass of a dispersion medium, and 6 parts by mass of an organic binder were added respectively, and they were mixed and kneaded to prepare a green body. The cordierite-forming raw material used was alumina, aluminum hydroxide, kaolin, talc, and silica, and the dispersion medium used was water. The organic binder used was methyl cellulose. The pore-forming used was a water-absorbent resin with a median diameter of 20 μm. Here, the median diameter of the raw material refers to the particle size at an integrated value of 50% (D50) in the particle size distribution obtained by a laser diffraction/scattering method.

Next, the green body was extrusion molded using a die for preparing a honeycomb formed body, to obtain a honeycomb formed body having an overall shape of a cylindrical shape. The structure of the die was changed depending on the test numbers.

Next, the honeycomb formed body was dried in a microwave dryer and further dried in a hot gas dryer, after which both end surfaces of the honeycomb formed body were cut to a predetermined size.

Next, a slurry for forming sealing portions was prepared using the same material as the honeycomb formed body. Thereafter, using this slurry, sealing portions were formed at the openings of the predetermined cells on the inlet end surface side and at the openings of the remaining cells on the outlet end surface side of the dried honeycomb formed body, such that the inlet cells and the outlet cells were alternately adjacent to each other.

Next, each of the honeycomb formed bodies after forming sealing portions was degreased and fired to produce a honeycomb structure according to each test number. The honeycomb structure thus obtained had a cylindrical shape with circular inlet and outlet end surfaces. The diameters of the inlet end surface and the outlet end surface were 228.6 mm. The length of the honeycomb structure in the direction in which the cells extend was 184.2 mm. The opening shape of the inlet cells was octagonal except for the one adjacent to the outer peripheral side wall. The shape of the openings of the outlet cells were square except for the one adjacent to the outer peripheral side wall. The average depth of the sealing portions at the inlet end surface and the outlet end surface was about 7 mm. A required number of the honeycomb structures to specify the following characteristics were prepared.

### B2. Structural Characteristics of Honeycomb Structure

Table 2 shows the structural characteristics of the honeycomb structures manufactured as above according to each test number.
Cell density
Average thickness of the partition walls
Average value Dᵢₙ of the opening diameters of the plurality of inlet cells except for those adjacent to the outer peripheral side wall
Average value Dₒᵤₜ of the opening diameters of the plurality of outlet cells except for those adjacent to the outer peripheral side wall

$$Opening diameter ratio ( {D}_{i n} / {D}_{out} )$$

Average porosity of partition walls
Ratio of the number of inlet cells to the number of outlet cells
Density (mass of honeycomb structure/external dimensions)

The cell density means the cell density based on the total number of inlet cells and outlet cells, and was measured according to the method described above.

The average thickness of the partition walls was measured by observation with a scanning electron microscope (SEM) or by using a microscope.

The opening diameters of the inlet cell and the outlet cell were calculated by observation with a scanning electron microscope (SEM) or using a microscope.

The average value Dₒᵤₜ was calculated based on the opening diameters of all the outlet cells except for those adjacent to the outer peripheral side wall among the plurality of outlet cells.

The average value Dᵢₙ was calculated based on the opening diameters of all the inlet cells except for those adjacent to the outer peripheral side wall among the plurality of inlet cells.

The porosity of the partition walls was measured by the above-mentioned mercury intrusion method using Autopore 9500 (product name) manufactured by Micromeritics Instrument Corporation.

The ratio of the number of inlet cells to the number of outlet cells was calculated by visually counting the number of outlet cells and the number of inlet cells.

The average pore diameter of the partition walls was measured by the above-mentioned mercury intrusion method using Autopore 9500 (product name) manufactured by Micromeritics.

### B3. Functional Properties of Honeycomb Structure

The honeycomb structures according to the respective test numbers prepared above were used as exhaust gas filters, and the pressure loss characteristics were investigated in the same manner as in the honeycomb structures of the above-mentioned Example 1-1 and the like. The results are shown in Table 2.

TABLE 2

| | | Parti- | | | | | | | | | | | |
|---|---|---|---|---|---|---|---|---|---|---|---|---|---|
| | | tion | | | | Parti- | | | | | | | |
| | | wall | Inlet | Outlet | | tion | | | | | | | Pressure |
| | | average | cell | cell | Opening | wall | Ratio of | Average | | Initial | | | loss |
| | Cell | thick- | opening | opening | diameter | average | inlet cells | pore | | pressure | | | gradient |
| | density | ness | diameter | diameter | ratio | porosity | number/outlet | diameter | Density | loss | P₁ | P₂ | (P₂ − |
| Reference | #/cm² | mm | Dᵢₙ mm | Dₒᵤₜ mm | Dᵢₙ/Dₒᵤₜ | % | cells number | μm | g/cm³ | kPa | kPa | kPa | P₁)/P₁ |
| Comparative | 47 | 0.241 | 1.39 | 1.07 | 1.30 | 52 | 1.0 | 13 | 0.410 | 1.17 | 2.61 | 3.69 | 41% |
| Example 2-1 | | | | | | | | | | | | | |
| Comparative | 47 | 0.191 | 1.44 | 1.12 | 1.29 | 52 | 1.0 | 13 | 0.343 | 0.97 | 2.26 | 3.26 | 44% |
| Example 2-2 | | | | | | | | | | | | | |
| Comparative | 36 | 0.320 | 1.52 | 1.20 | 1.27 | 60 | 1.0 | 10 | 0.385 | 1.18 | 2.26 | 3.70 | 64% |
| Example 2-3 | | | | | | | | | | | | | |
| Comparative | 37 | 0.310 | 1.49 | 1.17 | 1.27 | 60 | 1.0 | 10 | 0.385 | 1.21 | 2.25 | 3.63 | 61% |
| Example 2-4 | | | | | | | | | | | | | |
| Comparative | 30 | 0.226 | 1.88 | 1.56 | 1.21 | 60 | 1.0 | 10 | 0.280 | 0.75 | 1.69 | 3.16 | 87% |
| Example 2-5 | | | | | | | | | | | | | |
| Comparative | 34 | 0.292 | 1.66 | 1.18 | 1.41 | 60 | 1.0 | 10 | 0.351 | 1.18 | 2.21 | 3.58 | 62% |
| Example 2-6 | | | | | | | | | | | | | |
| Comparative | 30 | 0.292 | 1.61 | 1.45 | 1.11 | 60 | 1.0 | 10 | 0.340 | 0.84 | 2.00 | 3.71 | 86% |
| Example 2-7 | | | | | | | | | | | | | |
| Example 2-1 | 33 | 0.241 | 1.67 | 1.35 | 1.24 | 60 | 1.0 | 10 | 0.303 | 0.84 | 1.78 | 3.19 | 79% |
| Example 2-2 | 32 | 0.254 | 1.68 | 1.36 | 1.24 | 60 | 1.0 | 10 | 0.365 | 0.86 | 1.83 | 3.29 | 80% |
| Example 2-3 | 31 | 0.279 | 1.68 | 1.36 | 1.24 | 60 | 1.0 | 10 | 0.331 | 0.91 | 1.96 | 3.48 | 78% |
| Example 2-4 | 30 | 0.292 | 1.69 | 1.37 | 1.23 | 60 | 1.0 | 10 | 0.339 | 0.92 | 2.01 | 3.59 | 79% |
| Example 2-5 | 33 | 0.259 | 1.63 | 1.31 | 1.24 | 58 | 1.0 | 12 | 0.332 | 0.87 | 2.27 | 3.68 | 62% |
| Example 2-6 | 36 | 0.312 | 1.52 | 1.20 | 1.27 | 60 | 1.0 | 10 | 0.381 | 1.16 | 2.23 | 3.66 | 64% |
| Example 2-7 | 29 | 0.241 | 1.76 | 1.44 | 1.22 | 60 | 1.0 | 10 | 0.291 | 0.77 | 1.76 | 3.28 | 86% |
| Example 2-8 | 31 | 0.231 | 1.73 | 1.41 | 1.23 | 60 | 1.0 | 10 | 0.288 | 0.78 | 1.72 | 3.17 | 84% |
| Example 2-9 | 34 | 0.292 | 1.64 | 1.20 | 1.37 | 60 | 1.0 | 10 | 0.352 | 1.14 | 2.16 | 3.55 | 64% |
| Example | 30 | 0.292 | 1.63 | 1.43 | 1.14 | 60 | 1.0 | 10 | 0.337 | 0.86 | 1.98 | 3.64 | 84% |
| 2-10 | | | | | | | | | | | | | |

### Discussion

Comparative Examples 2-1 to 2-7 had an inappropriate combination of cell density, average partition wall thickness, pore diameter ratio, and average partition wall porosity. This resulted in excessively large pressure loss, a small pressure loss gradient, and a decrease in density (decreased heat capacity). In contrast, Examples 2-1 to 2-10 had appropriate cell density, partition wall thickness, pore diameter ratio, and the like, so the initial pressure loss and pressure loss during soot deposition were not excessively large, while a large pressure loss gradient was obtained. Also, the heat capacity was practical in view of the density.

### DESCRIPTION OF REFERENCE NUMERALS

100: Honeycomb structure
102: Outer peripheral side wall
104: Inlet end surface
106: Outlet end surface
107: Opening
108: Inlet cell
109: Sealing portion
110: Outlet cell
112: Partition wall
120: Chuck
121: Film
122: Squeegee
124: Sealing portion forming slurry
125: Cell
126: Hole
400: Honeycomb formed body

1. A pillar-shaped honeycomb structure, comprising:
an outer peripheral side wall;
a plurality of inlet cells arranged on an inner peripheral side of the outer peripheral side wall, extending from an inlet end surface to an outlet end surface, having an opening at the inlet end surface, and having a sealing portion at the outlet end surface; and
a plurality of outlet cells arranged on the inner peripheral side of the outer peripheral side wall, extending from the inlet end surface to the outlet end surface, having a sealing portion at the inlet end surface, and having an opening at the outlet end surface;
wherein at least a part of the plurality of inlet cells are adjacent to at least a part of the plurality of outlet cells with each of partition walls interposed therebetween,
wherein a cell density based on a total number of the plurality of inlet cells and the plurality of outlet cells is 29 to 43 cells/cm²,
wherein an average thickness of the partition walls is 0.173 mm or more and 0.236 mm or less, and
wherein assuming an average value of opening diameters of the plurality of outlet cells except for those adjacent to the outer peripheral side wall is Dₒᵤₜ, and an average value of opening diameters of the plurality of inlet cells except for those adjacent to the outer peripheral side wall is Dᵢₙ, 1.20≤Dᵢₙ/Dₒᵤₜ≤1.38 is satisfied.

2. The honeycomb structure according to claim 1, wherein the average value Dᵢₙ of the opening diameters of the plurality of inlet cells except for those adjacent to the outer peripheral side wall is 1.48 mm or more and 1.80 mm or less, and
the average value Dₒᵤₜ of the opening diameters of the plurality of outlet cells except for those adjacent to the outer peripheral side wall is 1.16 mm or more and 1.48 mm or less.

3. The honeycomb structure according to claim 1, wherein the partition walls have an average porosity of 52 to 60%.

4. The honeycomb structure according to claim 1, wherein a density measured based on outer dimensions is 0.288 to 0.410 g/cm³.

5. The honeycomb structure according to claim 1, wherein a ratio of a number of the plurality of inlet cells except for those adjacent to the outer peripheral side wall to a number of the plurality of outlet cells except for those adjacent to the outer peripheral side wall is 0.9 to 1.1.

6. The honeycomb structure according to claim 1, wherein when a deposition mass of particulate matter comprising soot per unit volume of the honeycomb structure is 1 g/L, assuming a pressure loss when exhaust gas having a temperature of 250° C. and a flow rate of 480 kg/hr passes from the inlet end surface to the outlet end surface is defined as P₁, and
when a deposition mass of particulate matter comprising soot per unit volume of the honeycomb structure is 3 g/L, assuming a pressure loss when exhaust gas having a temperature of 250° C. and a flow rate of 480 kg/hr passes from the inlet end surface to the outlet end surface is defined as P₂,
$$45 \% \leq ( {P}_{2} - {P}_{1} ) / {P}_{1} is satisfied .$$

7. The honeycomb structure according to claim 1, wherein the partition walls comprise cordierite.

8. A pillar-shaped honeycomb structure, comprising:
an outer peripheral side wall;
a plurality of inlet cells arranged on an inner peripheral side of the outer peripheral side wall, extending from an inlet end surface to an outlet end surface, having an opening at the inlet end surface, and having a sealing portion at the outlet end surface; and
a plurality of outlet cells arranged on the inner peripheral side of the outer peripheral side wall, extending from the inlet end surface to the outlet end surface, having a sealing portion at the inlet end surface, and having an opening at the outlet end surface;
wherein at least a part of the plurality of inlet cells are adjacent to at least a part of the plurality of outlet cells with each of partition walls interposed therebetween,
wherein a cell density based on a total number of the plurality of inlet cells and the plurality of outlet cells is 29 to 36 cells/cm²,
wherein an average thickness of the partition walls is 0.231 mm or more and 0.312 mm or less,
wherein assuming an average value of opening diameters of the plurality of outlet cells outlet cells except for those adjacent to the outer peripheral side wall is Dₒᵤₜ, and an average value of opening diameters of the plurality of inlet cells except for those adjacent to the outer peripheral side wall is Dᵢₙ, 1.14≤Dᵢₙ/Dₒᵤₜ≤1.37 is satisfied, and
wherein the partition walls have an average porosity of 57 to 63%.

9. The honeycomb structure according to claim 8, wherein the average value Dᵢₙ of the opening diameters of the plurality of inlet cells except for those adjacent to the outer peripheral side wall is 1.52 mm or more and 1.76 mm or less, and
the average value Dₒᵤₜ of the opening diameters of the plurality of outlet cells except for those adjacent to the outer peripheral side wall is 1.20 mm or more and 1.44 mm or less.

10. The honeycomb structure according to claim 8, wherein an average pore diameter of the partition walls is 7 to 13 μm.

11. The honeycomb structure according to claim 8, wherein a density measured from outer dimensions is 0.288 to 0.410 g/cm³.

12. The honeycomb structure according to claim 8, wherein a ratio of a number of the plurality of inlet cells except for those adjacent to the outer peripheral side wall to a number of the plurality of outlet cells except for those adjacent to the outer peripheral side wall is 0.9 to 1.1.

13. The honeycomb structure according to claim 8, wherein when a deposition mass of particulate matter comprising soot per unit volume of the honeycomb structure is 1 g/L, assuming a pressure loss when exhaust gas having a temperature of 250° C. and a flow rate of 480 kg/hr passes from the inlet end surface to the outlet end surface is defined as P₁, and
when a deposition mass of particulate matter comprising soot per unit volume of the honeycomb structure is 3 g/L, assuming a pressure loss when exhaust gas having a temperature of 250° C. and a flow rate of 480 kg/hr passes from the inlet end surface to the outlet end surface is defined as P₂,
$$45 \% \leq ( {P}_{2} - {P}_{1} ) / {P}_{1} is satisfied .$$

14. The honeycomb structure according to claim 8, wherein the partition walls comprise cordierite.
